(19) United States
(12) Patent Application Publication
(10) Pub. No.: US 2025/0131430 A1
(43) Pub. Date: Apr. 24, 2025

(54) SYSTEMS AND METHODS FOR USER AUTHENTICATION VIA A SUBSEQUENT AUTHENTICATION ON SOFTWARE APPLICATION

(71) Applicant: Capital One Services, LLC, McLean, VA (US)

(72) Inventors: Jeffrey Carlyle WIEKER, Falls Church, VA (US); Jeffrey RULE, Chevy Chase, MD (US)

(21) Appl. No.: 18/919,031

(22) Filed: Oct. 17, 2024

Related U.S. Application Data
(60) Provisional application No. 63/545,123, filed on Oct. 20, 2023.

(51) Int. Cl. G06Q 20/40; H04L 9/32

(52) U.S. Cl. CPC G06Q 20/401; H04L 9/3228

(57) ABSTRACT

Systems and methods of the present disclosure are directed to a secure and streamlined transaction process. The systems and methods involve an administrator processor that receives user data from a user device, encrypts it, and transmits it to multiple account processing systems, each linked to a different account provider. Upon receiving notifications from the account processing systems about the account holder's transaction account, the administrator processor sends an authentication request to the user device. The user responds with an authentication credential. The administrator processor then prompts the user to select an account provider and generates a universal resource locator that launches a software application on the user's device. Once the user authenticates through the application, a second confirmation is sent to the administrator processor, which forwards it to the selected account provider. The necessary transaction information is then received by the administrator processor.

### CROSS-REFERENCE TO RELATED APPLICATION

This patent document claims the priority of U.S. Provisional Patent Application No. 63/545,123, filed Oct. 20, 2023, the contents of which are incorporated herein by reference in their entireties.

### FIELD OF THE DISCLOSURE

The present disclosure relates to systems and methods for user authentication for performing an online transaction.

### BACKGROUND

Many consumers have multiple financial accounts among which they perform many different kinds of online transactions. But managing transactions across multiple accounts with different account providers can be complex and time-consuming, and users often have limited control and visibility over their transactions across various accounts. In addition, inefficient coordination between users, administrators, and account providers can lead to transaction delays and friction points while diminishing the user experience and potentially reducing the number of transactions that can be performed.

Further, users are often required to perform an authentication prior to accessing an account. However, traditional authentication methods can be cumbersome and may involve multiple steps. This can add further transaction delays and friction points while further diminishing the user experience and potentially reducing the number of transactions that can be performed.

These and other deficiencies exist. Therefore, there is a need to provide systems and methods for user authentication for performing an online transaction that overcome these deficiencies.

### SUMMARY OF THE DISCLOSURE

In some aspects, the techniques described herein relate to a method for completing a transaction including: receiving, by an administrator processor from a user device, a user datum; encrypting, by an administrator processor, the user datum; transmitting, by the administrator processor to each of a plurality of account processing systems, the encrypted user datum, wherein each account processing system is associated with a different account provider and has been provisioned with the user datum encryption information; receiving, by the administrator processor from at least one of the plurality of account processing systems, a response including a notification that the account holder has a transaction account processed by that account processing system; transmitting, by the administrator processor, an authentication request to the use device; receiving by the administrator processor an authentication credential from the user device, wherein the authentication credential includes a one-time password (OTP); transmitting, by the administrator processor to the user device, a confirmation request identifying the account providers associated with the at least one of the plurality of account processing system; receiving, by the administrator processor from the user device, a confirmation response including identification of a selected account provider; generating, by the administrator processor a uniform resource location (URL) configured to launch a software application on the user device; transmitting, administrator processor, the URL to the user device; receiving, by the administrator processor from the software application, a second confirmation response where the user has authenticated himself via the software application on the user device; transmitting, by the administrator processor to the account processing system associated with the selected account provider, the confirmation response; receiving, by the administrator processor, the transaction information sufficient to complete a transaction.

In some aspects, the techniques described herein relate to a system including: an administrator processor configured to: receive, by an administrator processor from a user device, a user datum; encrypt, by an administrator processor, the user datum; transmit, by the administrator processor to each of a plurality of account processing systems, the encrypted user datum, receive, by the administrator processor from at least one of the plurality of account processing systems, a response including a notification that the account holder has a transaction account processed by that account processing system; transmit an authentication request to the use device; receive an authentication credential from the user device including a one-time password (OTP); transmit, by the administrator processor to the user device, a confirmation request identifying the account providers associated with the at least one of the plurality of account processing system; receive, by the administrator processor from the user device, a confirmation response including identification of a selected account provider; generate a uniform resource location (URL) configured to launch a software application associated with the selected account provider; transmit the URL to the user device; receive, by the administrator processor from the software application, a second confirmation response where the user has authenticated themselves via the software application on the user device; transmit, by the administrator processor to the account processing system associated with the selected account provider, the confirmation response; receive, by the administrator processor one or more transaction information sufficient to complete a transaction.

In some aspects, the techniques described herein relate to a non-transitory computer readable medium containing computer executable instructions that, when executed by an administrator processor, cause the an administrator processor to perform procedures including: receiving, from a user device, a user datum; encrypting the user datum; transmitting, to each of a plurality of account processing systems, the encrypted user datum, wherein each account processing system is associated with a different account provider and has been provisioned with the user datum encryption information; receiving, from at least one of the plurality of account processing systems, a response including a notification that the account holder has a transaction account processed by that account processing system; transmitting an authentication request to the use device; receiving an authentication credential from the user device including a one-time password (OTP); transmitting, to the user device, a confirmation request identifying the account providers associated with the at least one of the plurality of account processing system; receiving, from the user device, a confirmation response including identification of a selected account provider; generating a uniform resource location (URL) configured to launch a software application associated with the selected account provider; transmitting the URL to the user device; receiving, from the software application, a second confirmation response where the user has authenticated themselves via the software application on the user device; transmitting, to the account processing system associated with the selected account provider, the confirmation response; receiving the transaction information sufficient to complete a transaction.

Further features of the disclosed systems and methods, and the advantages offered thereby, are explained in greater detail hereinafter with reference to specific example embodiments illustrated in the accompanying drawings.

### BRIEF DESCRIPTION OF THE DRAWINGS

In order to facilitate a fuller understanding of the present invention, reference is now made to the attached drawings. The drawings should not be construed as limiting the present invention, but are intended only to illustrate different aspects and embodiments of the invention.

FIG. 1 illustrates a system according to an exemplary embodiment.

FIGS. 2A-2B illustrate a system according to an exemplary embodiment.

FIGS. 3A-3D illustrate a user device performing the authentication process according to an exemplary embodiment.

FIG. 4 illustrates a method according to an exemplary embodiment.

FIG. 5 illustrates a method according to an exemplary embodiment.

### DETAILED DESCRIPTION

Exemplary embodiments of the invention will now be described in order to illustrate various features of the invention. The embodiments described herein are not intended to be limiting as to the scope of the invention, but rather are intended to provide examples of the components, use, and operation of the invention.

Furthermore, the described features and advantages of the embodiments may be combined in any suitable manner. One skilled in the art will recognize that the embodiments may be practiced without one or more of the features or advantages of an embodiment, and one skilled in the art will recognize the features or advantages of an embodiment can be interchangeably combined with the features and advantages of any other embodiments. In other instances, additional features and advantages may be recognized in certain embodiments that may not be present in all embodiments.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Systems and methods of the present disclosure are directed to a secure and streamlined transaction process. The systems and methods of the present disclosure involve an administrator processor that receives user data from a user device, encrypts it, and then transmits it to multiple account processing systems, each linked to a different account provider. Upon receiving notifications from the account processing systems about the account holder's transaction account, the administrator processor sends an authentication request to the user device. The user responds with an authentication credential, typically a one-time password (OTP). The administrator processor then prompts the user to select an account provider and generates a universal resource locator (URL) that launches a software application on the user's device. Once the user authenticates themselves through the application, a second confirmation is sent to the administrator processor, which forwards it to the selected account provider. Finally, the transaction information needed to complete the transaction is received by the administrator processor, ensuring a secure and efficient process.

Systems and methods of the present disclosure provide numerous advantages. By encrypting user data and utilizing OTP for authentication, the systems and methods significantly enhances security, reducing the risk of unauthorized access to sensitive account information.

Furthermore, systems and methods of the present disclosure system efficiently manage multiple accounts associated with different account providers, streamlining the transaction process for users with diverse financial relationships. Additionally, the use of a software application on the user's device for a second and separate authentication makes the process more user-friendly and convenient, eliminating the need for complex authentication procedures.

Overall, systems and methods of the present disclosure optimize the transaction process by efficiently coordinating the exchange of information between the user, administrator, and account providers, reducing potential delays and friction points. This system can be adapted to accommodate a variety of account providers, making it versatile and applicable to a wide range of financial institutions and services. The secure and authenticated nature of this invention reduces the risk of fraudulent transactions, benefiting both users and account providers.

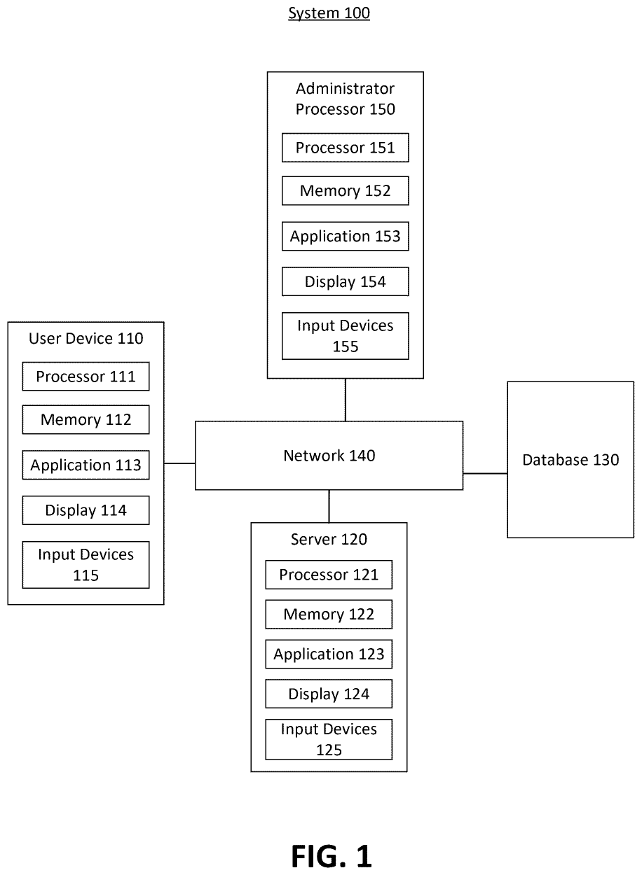

FIG. 1 illustrates a system 100 according to an exemplary embodiment. The system 100 may comprise a user device 110, a server 120, a database 130, a network 140, and an administrator processor 150. Although FIG. 1 illustrates single instances of components of system 100, system 100 may include any number of components.

System 100 may include a user device 110. The user device 110 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, a contactless card, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device. A wearable smart device can include without limitation a smart watch.

The user device 110 may include a processor 111, a memory 112, and an application 113. The processor 111 may be a processor, a microprocessor, or other processor, and the user device 110 may include one or more of these processors. The processor 111 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 111 may be coupled to the memory 112. The memory 112 may be a read-only memory, write-once read-multiple memory or read/write memory, e.g., RAM, ROM, and EEPROM, and the user device 110 may include one or more of these memories. A read-only memory may be factory programmable as read-only or one-time programmable. One-time programmability provides the opportunity to write once then read many times. A write-once read-multiple memory may be programmed at one point in time. Once the memory is programmed, it may not be rewritten, but it may be read many times. A read/write memory may be programmed and re-programed many times after leaving the factory. It may also be read many times. The memory 112 may be configured to store one or more software applications, such as the application 113, and other data, such as user's private data and financial account information.

The application 113 may comprise one or more software applications, such as a mobile application and a web browser, comprising instructions for execution on the user device 110. In some examples, the user device 110 may execute one or more applications, such as software applications, that, for example, enable network communications with one or more components of the system 100, transmit and/or receive data, and perform the functions described herein. Upon execution by the processor 111, the application 113 may perform the functions described in this specification, specifically to execute and perform the steps and functions in the process flows described herein. Such processes may be implemented in software, such as software modules, for execution by computers or other machines. The application 113 may provide graphical user interfaces (GUIs) through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The user device 110 may further include a display 114 and input devices 115. The display 114 may be any type of device for presenting visual information such as a computer monitor, a flat panel display, and a mobile device screen, including liquid crystal displays, light-emitting diode displays, plasma panels, and cathode ray tube displays. The input devices 115 may include any device for entering information into the user device 110 that is available and supported by the user device 110, such as a touch-screen, keyboard, mouse, cursor-control device, touch-screen, microphone, digital camera, video recorder or camcorder. These devices may be used to enter information and interact with the software and other devices described herein.

The server 120 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The server 120 can be onsite, offsite, standalone, networked, online, or offline.

The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user's private data and financial account information.

The application 123 may comprise one or more software applications comprising instructions for execution on the server 120. In some examples, the server 120 may execute one or more applications, such as software applications, that, for example, enable network communications with one or more components of the system 100, transmit and/or receive data, and perform the functions described herein. Upon execution by the processor 121, the application 123 may perform the functions described in this specification, specifically to execute and perform the steps and functions in the process flows described herein. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display 124 and input devices 125. The display 124 may be any type of device for presenting visual information such as a computer monitor, a flat panel display, and a mobile device screen, including liquid crystal displays, light-emitting diode displays, plasma panels, and cathode ray tube displays. The input devices 125 may include any device for entering information into the server 120 that is available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include a database 130. The database 130 may be one or more databases configured to store data, including without limitation, private data of users, financial accounts of users, identities of users, transactions of users, and certified and uncertified documents. The database 130 may comprise a relational database, a non-relational database, or other database implementations, and any combination thereof, including a plurality of relational databases and non-relational databases. In some examples, the database 130 may comprise a desktop database, a mobile database, or an in-memory database. Further, the database 130 may be hosted internally by the server 120 or may be hosted externally of the server 120, such as by a server, by a cloud-based platform, or in any storage device that is in data communication with the server 120.

System 100 may include one or more networks 140. In some examples, the network 140 may be one or more of a wireless network, a wired network or any combination of wireless network and wired network, and may be configured to connect the user device 110, the server 120, and the database 130. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

The administrator processor 150 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

The administrator processor 150 may include a processor 151, a memory 152, and an application 153. The processor 151 may be a processor, a microprocessor, or other processor, and the administrator processor 150 may include one or more of these processors.

The processor 151 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 151 may be coupled to the memory 152. The memory 152 may be a read-only memory, write-once read-multiple memory or read/write memory, e.g., RAM, ROM, and EEPROM, and the administrator processor 150 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 152 may be configured to store one or more software applications, such as the application 153, and other data, such as user's private data and financial account information.

The application 153 may comprise one or more software applications comprising instructions for execution on the administrator processor 150. In some examples, the administrator processor 150 may execute one or more applications, such as software applications, that, for example, enable network communications with one or more components of the system 100, transmit and/or receive data, and perform the functions described herein. Upon execution by the processor 151, the application 153 may perform the functions described in this specification, specifically to execute and perform the steps and functions in the process flows described herein. Such processes may be implemented in software, such as software modules, for execution by computers or other machines. The application 153 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The administrator processor 150 may further include a display 154 and input devices 155. The display 154 may be any type of device for presenting visual information such as a computer monitor, a flat panel display, and a mobile device screen, including liquid crystal displays, light-emitting diode displays, plasma panels, and cathode ray tube displays. The input devices 155 may include any device for entering information into the administrator processor 150 that is available and supported by the administrator processor 150, such as a touch-screen, keyboard, mouse, cursor-control device, touch-screen, microphone, digital camera, video recorder or camcorder. These devices may be used to enter information and interact with the software and other devices described herein.

The merchant processor 160 may be a network-enabled computer device. Exemplary network-enabled computer devices include, without limitation, a server, a network appliance, a personal computer, a workstation, a phone, a handheld personal computer, a personal digital assistant, a thin client, a fat client, an Internet browser, a mobile device, a kiosk, or other a computer device or communications device. For example, network-enabled computer devices may include an iPhone, iPod, iPad from Apple® or any other mobile device running Apple's iOS® operating system, any device running Microsoft's Windows® Mobile operating system, any device running Google's Android® operating system, and/or any other smartphone, tablet, or like wearable mobile device.

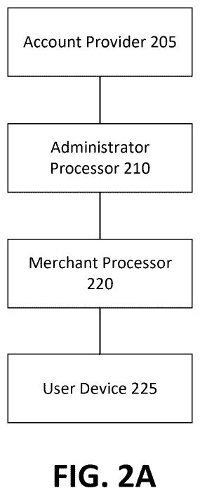

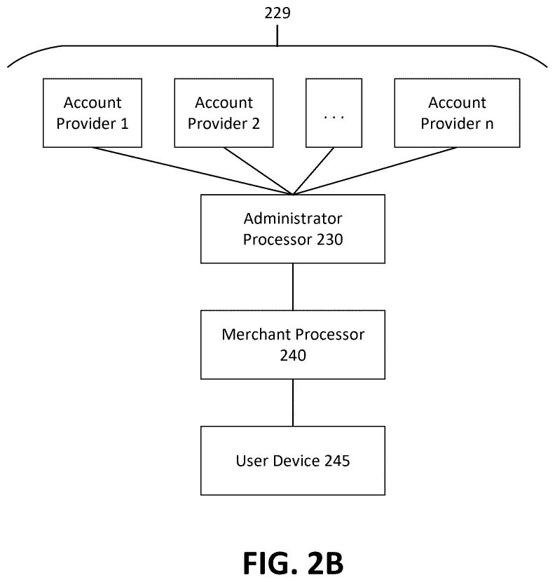

FIGS. 2A and 2B describe two embodiments of exemplary systems. In FIG. 2A, the administrator processor 220 is connected to a single account provider 205. An account provider can include a processor or server associated with a provider of personal financing and payment services, including without limitation checking accounts, savings accounts, credit accounts, or some combination thereof. For example, an account provider can include the credit card provider associated with a user's credit card. The administrator processor 210 can also be connected to a merchant processor 220 and a user device 225 over a network discussed with further reference to FIG. 1. The single account provider 205 can be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In this embodiment, the account provider 205 and the administrator processor 210 share information regarding the one or more transaction accounts associated with the account provider 205. In some embodiments, the administrator processor 210 may query the account provider 205 for each individual online transaction, e.g., the administrator processor 210 may make separate requests for payment credentials for each transaction. In other embodiments, the administrator processor 210 may have a relationship with the account provider 205 such that the payment credentials usually handled by the account provider 205 will be processed by the administrator processor 210 as well. That is, the administrator processor 210 already has the payment credentials, so the administrator processor 210 does not have to query the account provider 205 for every single transaction. This embodiment presumes that the administrator processor 210 and account provider 205 have already communicated with one another and have granted the administrator processor 210 the permission to have and use the payment credentials associated with one or more transaction accounts associated with the account provider 205.

In an exemplary embodiment, the user device 225 can be used to initiate an online consumer transaction associated with a particular merchant. The particular merchant can have a merchant processor 220. When the user device 225 initiates the online transaction, the merchant processor 220 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

In FIG. 2B, the administrator processor 230 can similarly be in communication with a merchant processor 240 and a user device 245 over one or more networks discussed with further reference to FIG. 1. In this embodiment, the administrator processor 230 can be associated with multiple account providers 229, for example Account Provider 1, Account Provider 2, . . . , up to Account Provider n. The account providers 229 can each be associated with a bank or banking application including one or more transaction accounts such as a checking, savings, or growth accounts. Furthermore, the accounts can be associated with one or more transaction cards such as credit cards, charge cards, debit cards, gift cards, rewards cards, or some other transaction card. In some embodiments, the administrator processor 210 may query the account providers 229 for each individual online transaction, e.g., the administrator processor 210 may make separate requests for payment credentials for each transaction. In other embodiments, the administrator processor 230 may have a relationship with the account providers 229 such that the payment credentials usually handled by the account providers 229 will be processed by the administrator processor 430 as well. That is, the administrator processor 230 already has the payment credentials, so the administrator processor 230 does not have to query the account providers 229 for every single transaction. This embodiment presumes that the administrator processor 230 and account providers 229 have already communicated with one another and have granted the administrator processor 230 the permission to have and use the payment credentials associated with one or more transaction accounts associated with the account providers 229.

In an exemplary embodiment, the user device 245 can be used to initiate an online consumer transaction associated with a particular merchant. The particular merchant can have a merchant processor 240. When the user device 245 initiates the online transaction, the merchant processor 240 can gather one or more information items about the transaction, including without limitation: IP address; browser configuration; network details; stock keeping unit (SKU) data associated with the online transaction; search activities; product page views; typing patterns; typing speeds; geolocation data; time and date data; user account history data; device information; referral source; and any combination thereof.

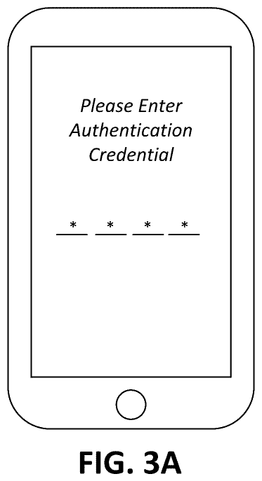

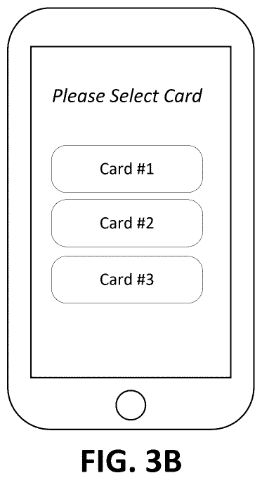

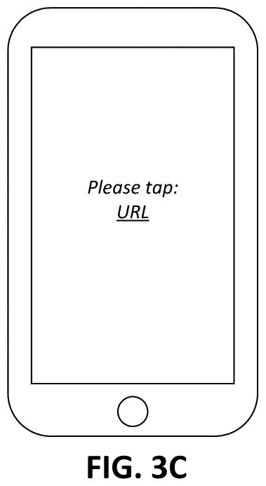

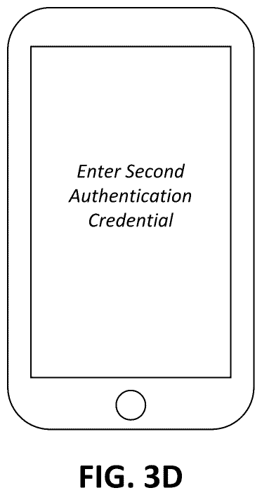

FIG. 3A-3D are diagrams illustrating a process according to an exemplary embodiment. Each of the actions illustrated in FIGS. 3A-3D can be performed by a user device application associated with the user device.

In FIG. 3A, the user device application receives an authentication request from the server and submits an authentication credential, such as a one time password (OTP) or personal identification number (PIN). The user device application securely communicates the entered PIN to the administrator processor using encryption protocols and secure network connections. Though only a PIN is illustrated in FIG. 3A, it is understood that other authentication credentials may be provided, including without limitation: a biometric such as a fingerprint scan, facial recognition (e.g. face identifier (ID)), iris scanning, and voice scanning; a PIN or passcode; or a security token.

In FIG. 3B, the user device application receives a list of transaction accounts associated with the information provided by the user at checkout. The administrator processor processes the authentication request and retrieves the user's profile information. This includes the user's email address and other identifiers obtained from the checkout process. The administrator processor then queries the relevant transaction account processing systems (e.g. banks) to retrieve the list of transaction accounts associated with the user's profile. This retrieval process can involve without limitation database queries, application programming interface (API) calls, or other mechanisms to fetch the necessary data. More specifically, the administrator processor can integrate with the banks' APIs by establishing a connection and communicating with them. The administrator processor sends requests to specific endpoints provided by the banks' API systems. To retrieve account information, the administrator processor can send a GET request to the appropriate API endpoint provided by the bank. The request may include parameters such as the user's authentication credentials, account number, or any other relevant details required by the API. The bank's API processes the request and generates a response. The response usually contains the requested account information, such as the account balance, transaction history, or other relevant data. The administrator processor can store the retrieved account information in a database or use it for further processing, analysis, or display within the application. The administrator processor can also aggregate data from multiple banks if needed, by making separate API requests to each bank's API and consolidating the responses.

Furthermore, the one or more accounts provided by the bank or account providers can be associated with one or more transaction cards such as credit cards, charge cards, debit cards, gift cards, rewards cards, or some other transaction card. In some embodiments, the bank and the administrator processor share information regarding the one or more transaction accounts associated with the user. In some embodiments, the administrator processor may query the bank through the API for each individual online transaction, i.e. the administrator processor may make separate requests for payment credentials for each transaction. In other embodiments, the administrator processor may have a relationship with the bank such that the payment credentials usually handled by the bank will be possessed by the administrator processor as well. That is, the server already has the payment credentials, so the administrator processor does not have to query the bank for every single transaction. This embodiment presumes that the administrator processor and the bank have already communicated with one another and have granted the administrator processor the permission to have and use the payment credentials associated with one or more transaction accounts associated with the user.

Once retrieved, the administrator processor transmits the list of transaction accounts to the user's user device application using secure communication channels and data serialization formats such as JSON or XML. The list can be shown on the user device's display, and the user can select one of many account. The user can choose from one of three options labeled “Card #1,” “Card #2,” and “Card #3.” In other embodiments, the user can be provided with more or fewer selections. Each card can be associated with one or more transaction accounts associated with potentially one or more account providers.

In FIG. 3C, the user device upon selecting a card will receive from the administrator processor a URL configured to open a software application associated with the selected card on the user device. For example, if the user selected “Card #2,” then the URL will open the software application associated with “Card #2.” In some embodiments, the URL can be a universal URL configured to handle scenarios where a user device or mobile device has a specific application installed or does not have the application installed. This can be achieved through deep linking or smart linking. Deep linking allows one to associate a URL with a specific action or content within a mobile application. When a user clicks on a deep link, the operating system associated with the user device checks if the corresponding application is installed on the user device. To handle scenarios where the application is not installed, one can set up a fallback URL or webpage. If the application is present, it opens directly to the specified content or performs the associated action. If the application is not installed, the URL can redirect the user via the user device to a fallback webpage. This fallback URL can be a regular web URL that users are redirected to if the application is not detected on their mobile device. By combining deep linking and a fallback URL, one can create a URL that intelligently handles both cases. When the user clicks the link, their user device checks for the application and opens it if available. If the application is not installed, the user device automatically redirects to the fallback webpage.

Once the user device opens the software application associated with the selected card or transaction account, in FIG. 3D the user is prompted to enter a second authentication credential such as without limitation: a biometric such as a fingerprint scan, facial recognition (e.g. face ID), iris scanning, and voice scanning; a PIN or passcode; or a security token. Once the user has provided the second authentication credential to the software application, the administrator processor will receive a notification that the user has provided the credential i.e. that the user has authenticated himself within the software application. Next, the administrator processor can perform the transaction with the user's selected card or transaction account.

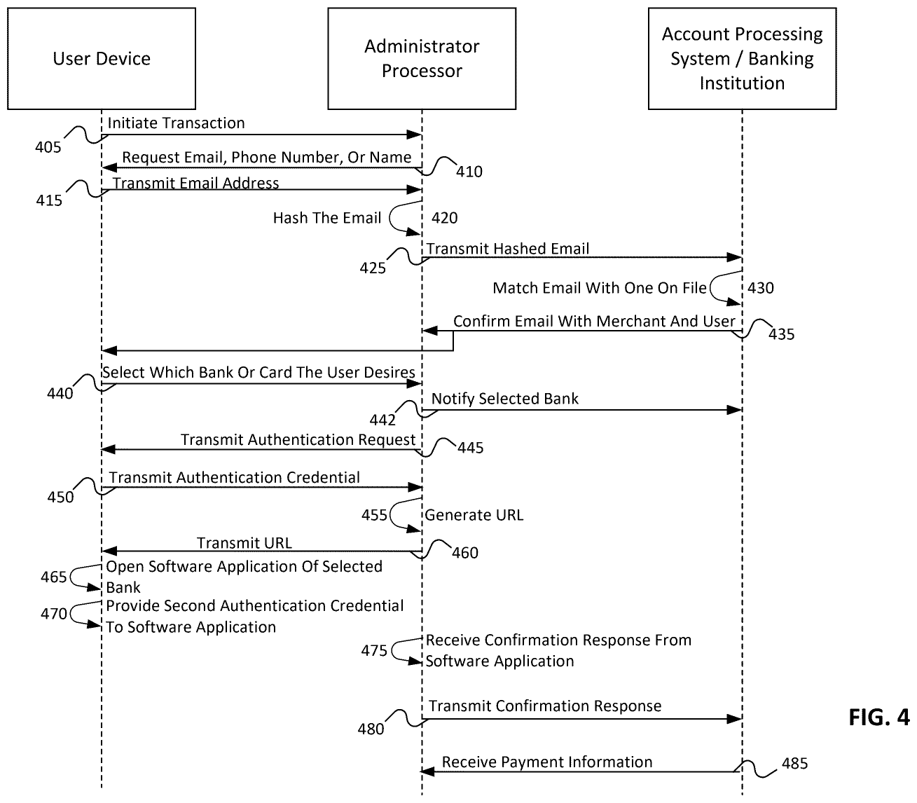

FIG. 4 illustrates a sequence diagram of an exemplary embodiment. The sequence 400 operates under the implication that the administrator data processor is associated with a merchant, and the account processing system is associated with a banking institution holding a contactless card account for the user. The banking institution may be one of multiple banks partnering with the merchant to provide secure account holder identification through the use of shared datum encryption information and method and an agreed-upon user datum. It is understood that the banking institutions may use a web application or mobile application to verify the user authentication credential.

In action 405, the user device initiates a transaction. This action can be performed by a processor associated with the user device, and it can be transmitted over a network. For example, the user device may be on the checkout page of an online transaction.

In action 410, the administrator processor requests from the user personal identity information including, at least, the agreed-upon user datum. Examples of personal identity information can include without limitation email addresses, phone number, or names. In action 415, the user device responds to the request with the appropriate information including the user datum. Although FIG. 4 illustrates the user datum as an email address, it is understood that other personal information may be used.

In some embodiments, the administrator processor can determine a security assessment of the transaction profile information. In making the security assessment, the administrator processor can determine, based on the given transaction profile information, the likelihood of fraud associated with the present online transaction. The administrator processor can make this determination based on whether the transaction profile alone or in combination should be associated with fraudulent activity. For example, the merchant processor can determine that the IP address associated with the user device is far away from the user device's historical geolocation data. In other nonlimiting embodiments, the administrator processor can collect user behaviors associated with performing transactions including without limitation: spending history associated with the user and the merchant; purchase patterns; Wi-Fi networks; browser configurations; and other user behaviors. For example, the administrator processor an identify the Wi-Fi network associated with the user's device, then determine if the identified network matches the network historically used by the user device, most often used by the user, or a network that has ever been used by the user device. In still other embodiments, user behavior can include spending history associated with the merchant; repetition of purchases; how often purchases occurred with respect to the certain merchant; and general price range associated with the user's purchase history.

Having reviewed the transaction profile information, the administrator processor can grade the online transaction on a scale of low risk, medium risk, and high risk. In other embodiments, the administrator processor may only grade for low risk or high risk. In still other embodiments, the administrator processor generate a numerical score or letter grade each with discrete value. In still other embodiments, the administrator processor can generate a slidable scale of riskiness associated with the online transaction. In some embodiments, if an administrator processor determines that there is a risk of fraud or a high likelihood of fraud, then the administrator processor can request additional authentication requests from the user device such as a second, third, or fourth authentication request. In turn, the administrator processor can receive one or more corresponding authentication credentials such as a biometric such as a fingerprint scan, facial recognition (e.g. face ID), iris scanning, and voice scanning; a PIN or passcode; or a security token.

In action 420, the administrator processor hashes the user datum provided by the user. This protects the identity information associated with the user. In action 425, the administrator processor transmits the hashed user datum to one or more banking institutions. It is understood that the administrator processor may have a pre-existing relationship with one more banking institutions so that transmission occurs more quickly. The administrator processor can prompt the user to select particular banking institutions he wishes to send the hashed email.

In action 430, one or more banking institutions can compare the hashed datum from the administrator processor with hashed datum values previously established using the shared encryption information and method and user data for account holders. This step can be performed by a processor associated with the administrator processor. If the banking institution matches the hashed datum with a hashed datum on file, this means that the user has an existing account associated with the banking institution. The existing account can be a spending account, growth account, or savings account.

After matching the user's datum with one on file, one or more banking institutions transmits a confirmation message or confirmation response to the administrator processor and user device in action 435, or alternatively just the administrator processor. This action can be performed by a processor associated with the banking institution. In some embodiments, the confirmation message may be sent to the user device via the administrator processor. In other embodiments, the confirmation message may be sent directly to the user device and not to the administrator processor. If multiple banks have confirmed the datum, then the user can select which account the user desires to use and transmit the selection to the administrator processor in action 440. This allows for greater spending freedom for the user. This action may be performed by a processor associated with the user device.

Upon receiving a selection from the user, the administrator processor may send a notification to the selected bank in action 442. In action 445, the administrator processor transmits an authentication request or confirmation authentication request to the user. The authentication request is meant to verify the user's identity, his or her information, and generally to protect against fraud. This action may be performed by a processor associated with the bank or some other server.

In response to the authentication request, the user can send one or more authentication credentials or confirmation responses to the administrator processor in action 450. The credentials can include without limitation a one-time-password (OTP), a PIN, or a biometric. It is understood that one or more credential can be used and that multi-factor information may be used as well. This action can be performed by a processor associated with the user device. The authentication credential can be transmitted over a network to the administrator processor which can also verify the authentication credential. In alternative embodiments, the user may transmit the authentication credential directly to the banking institution.

In action 455, the administrator processor can generate a URL. The URL can be configured to open a software application associated with the selected bank on the user device. For example, if the user selected “Bank #1,” then the URL will open the software application associated with “Bank #1.” In some embodiments, the URL can be a universal URL configured to handle scenarios where a user device or mobile device has a specific application installed or does not have the application installed. This can be achieved through deep linking or smart linking. Deep linking allows one to associate a URL with a specific action or content within a mobile application. When a user clicks on a deep link, the operating system associated with the user device checks if the corresponding application is installed on the user device. To handle scenarios where the application is not installed, one can set up a fallback URL or webpage. If the application is present, it opens directly to the specified content or performs the associated action. If the application is not installed, the URL can redirect the user via the user device to a fallback webpage. This fallback URL can be a regular web URL that users are redirected to if the application is not detected on their mobile device. By combining deep linking and a fallback URL, one can create a URL that intelligently handles both cases. When the user clicks the link, their user device checks for the application and opens it if available. If the application is not installed, the user device automatically redirects to the fallback webpage.

Having generated the URL, in action 460 the administrator processor can transmit the URL to the user device. The user device in action 465 can interact with the URL and be directed to the software application associated with the selected bank. As stated previously, if the application is not installed, the user device automatically redirects to the fallback webpage.

In action 470, the user via the user device can provide a second authentication credential via the software application. The credential can include a biometric such as a fingerprint scan, facial recognition (e.g. face ID), iris scanning, and voice scanning; a PIN or passcode; or a security token. The software application can independently verify the second authentication credential and share the verification with the user device.

In action 475, the administrator processor can receive a confirmation response from the software application sufficient to show the administrator processor that the user has authenticated himself on the software application.

In action 480, the administrator processor transmits the confirmation response to the selected account processing system or banking institution. The selected account processing systems and administrator processor can have an established agreement that, if the administrator processor provides the account processing system with a confirmation response, then the account processing system will provide the administrator processor with payment information from the selected transaction account. In action 485, the administrator processor receives this payment information from the account processing system, at which point the administrator processor can perform or complete a transaction with the payment information.

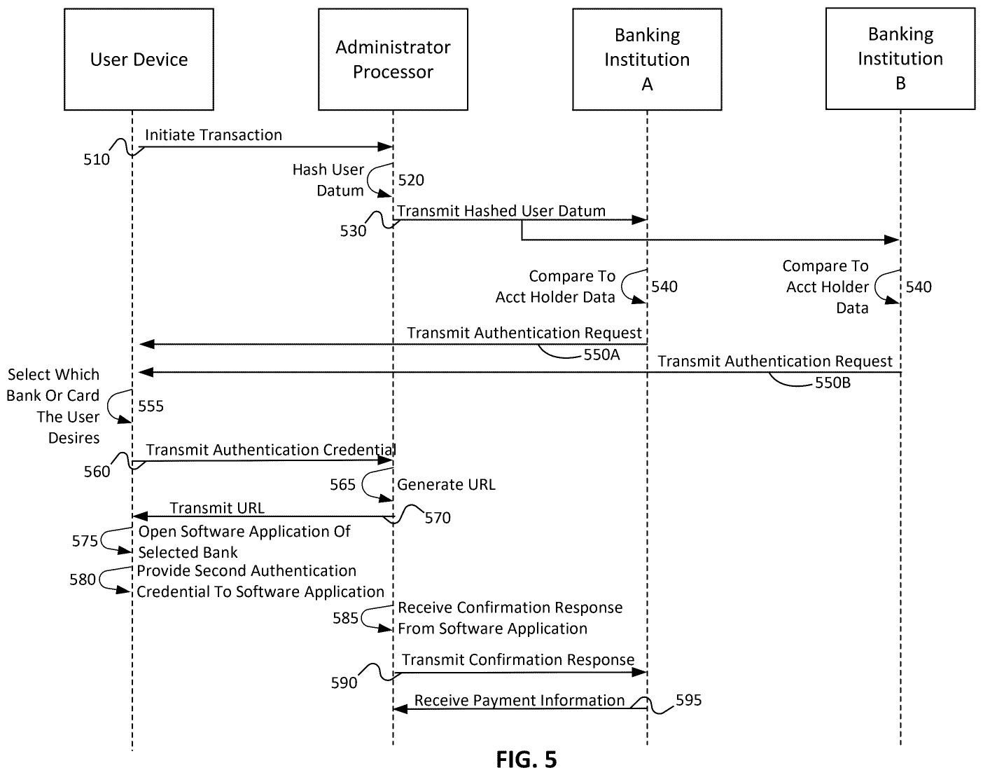

FIG. 5 illustrates a sequence diagram of an exemplary embodiment. All actions in the sequence may be carried out by automated data processing systems except for actions taken by a user. The sequence 500 operates under the implication that the administrator processor is associated with a merchant, and that there is a plurality of account processing systems, each associated with a banking institution, one or more of which have a contactless card account for the user. The banking institutions may be partnering with the administrator processor to provide secure account holder identification through the use of shared datum encryption information and method and an agreed-upon user datum type. As previously discussed, this may be an email address, phone number or other common user-associated datum typically included a user's account information.

In action 510, the administrator processor receives a request to perform an online transaction. This may be received as part of an interactive communication session over the web (e.g., through a merchant website) or through a one-time request received via email or direct transmission communication. The request may include a user-supplied user datum of the type agreed upon by the partner institutions. In some embodiments, the user datum may be provided by the user upon request by the merchant.

In action 520, the administrator processor hashes the user datum provided by the user. This protects the identity information associated with the user. In action 530, the administrator processor transmits the hashed user datum to the partner banking institutions, which include Banking Institution A and Banking Institution B. It is understood that the administrator processor may have a pre-existing relationship with the banking institutions so that transmission occurs more quickly. In action 540, each of the banking institutions compares the hashed datum from the administrator processor with hashed datum values previously established using the shared encryption information and method and known user data for existing account holders. If the banking institution matches the hashed datum with a hashed datum on file, this means that the user has an existing account associated with the banking institution. The existing account can be a spending account, growth account, or savings account. The bank may then retrieve user account information for the account associated with the matching hashed datum.

In the exemplary sequence 500, Banking Institutions A and B both determine that they have a matching hashed datum, indicating they both have card accounts for the user. In action 550A, Banking Institutions A retrieves user device information for a user device associated with the user/account holder and transmits an authentication request to the user device over a network. In typical embodiments, this may be in the form of a text message. In action 550B, Banking Institution B similarly transmits an authentication request to the user device. Each authentication request may identify the banking institution, and request that the user respond with user authentication information as a confirmation that the user wishes to obtain the payment information from that bank. The requested authentication information may be or include, for example, a password, an OTP, a PIN, or a biometric characteristic. It is understood that one or more credential may be requested and that multi-factor information may be used as well.

Having received authentication requests from multiple banks, the user, at action 555, decides as to which bank and card account he wishes to use. In the exemplary scenario, the user selects Banking Institution A, and, at action 560, the user device transmits the requested authentication information to administrator processor, which verifies the authentication information.

In action 565, the administrator processor can generate a URL. The URL can be configured to open a software application associated with the selected bank on the user device. For example, if the user selected “Banking Institution A,” then the URL will open the software application associated with “Banking Institution A.” In some embodiments, the URL can be a universal URL configured to handle scenarios where a user device or mobile device has a specific application installed or does not have the application installed. This can be achieved through deep linking or smart linking. Deep linking allows one to associate a URL with a specific action or content within a mobile application. When a user clicks on a deep link, the operating system associated with the user device checks if the corresponding application is installed on the user device. To handle scenarios where the application is not installed, one can set up a fallback URL or webpage. If the application is present, it opens directly to the specified content or performs the associated action. If the application is not installed, the URL can redirect the user via the user device to a fallback webpage. This fallback URL can be a regular web URL that users are redirected to if the application is not detected on their mobile device. By combining deep linking and a fallback URL, one can create a URL that intelligently handles both cases. When the user clicks the link, their user device checks for the application and opens it if available. If the application is not installed, the user device automatically redirects to the fallback webpage.

Having generated the URL, in action 570 the administrator processor can transmit the URL to the user device. The user device in action 575 can interact with the URL and be directed to the software application associated with the selected bank such as Banking Institution A. As stated previously, if the application is not installed, the user device automatically redirects to the fallback webpage.

In action 580, the user via the user device can provide a second authentication credential via the software application. The credential can include a biometric such as a fingerprint scan, facial recognition (e.g. face ID), iris scanning, and voice scanning; a PIN or passcode; or a security token. The software application can independently verify the second authentication credential and share the verification with the user device.

In action 585, the administrator processor can receive a confirmation response from the software application sufficient to show the administrator processor that the user has authenticated himself on the software application.

In action 590, the administrator processor transmits the confirmation response to the selected account processing system such as Banking Institution A. The selected account processing systems and administrator processor can have an established agreement that, if the administrator processor provides the account processing system with a confirmation response, then the account processing system will provide the administrator processor with payment information from the selected transaction account. In action 595, the administrator processor receives this payment information from Banking Institution A, at which point the administrator processor can perform or complete a transaction with the payment information.

In some aspects, the techniques described herein relate to a method for completing a transaction including: receiving, by an administrator processor from a user device, a user datum; encrypting, by an administrator processor, the user datum; transmitting, by the administrator processor to each of a plurality of account processing systems, the encrypted user datum, wherein each account processing system is associated with a different account provider and has been provisioned with the user datum encryption information; receiving, by the administrator processor from at least one of the plurality of account processing systems, a response including a notification that the account holder has a transaction account processed by that account processing system; transmitting, by the administrator processor, an authentication request to the use device; receiving by the administrator processor an authentication credential from the user device, wherein the authentication credential includes a one-time password (OTP); transmitting, by the administrator processor to the user device, a confirmation request identifying the account providers associated with the at least one of the plurality of account processing system; receiving, by the administrator processor from the user device, a confirmation response including identification of a selected account provider; generating, by the administrator processor a uniform resource location (URL) configured to launch a software application on the user device; transmitting, administrator processor, the URL to the user device; receiving, by the administrator processor from the software application, a second confirmation response where the user has authenticated himself via the software application on the user device; transmitting, by the administrator processor to the account processing system associated with the selected account provider, the confirmation response; receiving, by the administrator processor, the transaction information sufficient to complete a transaction.

In some aspects, the techniques described herein relate to a method, wherein the user datum is one of a phone number or an email address.

In some aspects, the techniques described herein relate to a method, wherein the user datum includes at least one of a home address, a billing address, a mobile phone number, a home phone number, an Email address.

In some aspects, the techniques described herein relate to a method, wherein the software application associated with the selected account provider is a mobile banking app.

In some aspects, the techniques described herein relate to a method, wherein the confirmation response from the software application includes biometric authentication data.

In some aspects, the techniques described herein relate to a method, wherein the authentication request is transmitted via a short message service (SMS) from the administrator processor to the user device.

In some aspects, the techniques described herein relate to a method, wherein if the user device does not have the software application associated with the URL, the URL will prompt the user device to download the software application.

In some aspects, the techniques described herein relate to a method, wherein the URL is configured to launch one of a plurality of software applications downloaded on the user device.

In some aspects, the techniques described herein relate to a method, wherein the URL is configured to launch the software application associated with the selected account provider.

In some aspects, the techniques described herein relate to a system including: an administrator processor configured to: receive, by an administrator processor from a user device, a user datum; encrypt, by an administrator processor, the user datum; transmit, by the administrator processor to each of a plurality of account processing systems, the encrypted user datum, receive, by the administrator processor from at least one of the plurality of account processing systems, a response including a notification that the account holder has a transaction account processed by that account processing system; transmit an authentication request to the use device; receive an authentication credential from the user device including a one-time password (OTP); transmit, by the administrator processor to the user device, a confirmation request identifying the account providers associated with the at least one of the plurality of account processing system; receive, by the administrator processor from the user device, a confirmation response including identification of a selected account provider; generate a uniform resource location (URL) configured to launch a software application associated with the selected account provider; transmit the URL to the user device; receive, by the administrator processor from the software application, a second confirmation response where the user has authenticated themselves via the software application on the user device; transmit, by the administrator processor to the account processing system associated with the selected account provider, the confirmation response; receive, by the administrator processor one or more transaction information sufficient to complete a transaction.

In some aspects, the techniques described herein relate to a system, wherein the user device is used by a user to perform the transaction on a website or application associated with the administrator processor.

In some aspects, the techniques described herein relate to a system, wherein each account processing system is associated with a different account provider and has been provisioned with the user datum encryption information.

In some aspects, the techniques described herein relate to a system, wherein the administrator processor is further configured to transmit, upon receiving the transaction information sufficient to complete a transaction, the transaction information to a transaction processor configured to process the transaction.

In some aspects, the techniques described herein relate to a system, wherein the administrator processor is further configured to receive a message indicating whether the transaction has been completed successfully.

In some aspects, the techniques described herein relate to a system, wherein each of the account providers are associated with a transaction card owned by the user associated with the use device.

In some aspects, the techniques described herein relate to a system, wherein the URL is configured such that if the user device has a plurality of software applications, then the URL will prompt the user device to selected one of the plurality of software applications to open.

In some aspects, the techniques described herein relate to a system, wherein the URL is configured to open the most recently used software application.

In some aspects, the techniques described herein relate to a system, wherein upon receiving the user datum, the administrator processor retrieves one or more historical transaction data associated with the user and determines whether the current transaction is likely fraudulent.

In some aspects, the techniques described herein relate to a system, wherein upon determining that the current transaction is likely fraudulent, transmitting a third authentication request to the user device, and receiving from the user device a third authentication credential.

In some aspects, the techniques described herein relate to a non-transitory computer readable medium containing computer executable instructions that, when executed by an administrator processor, cause the an administrator processor to perform procedures including: receiving, from a user device, a user datum; encrypting the user datum; transmitting, to each of a plurality of account processing systems, the encrypted user datum, wherein each account processing system is associated with a different account provider and has been provisioned with the user datum encryption information; receiving, from at least one of the plurality of account processing systems, a response including a notification that the account holder has a transaction account processed by that account processing system; transmitting an authentication request to the use device; receiving an authentication credential from the user device including a one-time password (OTP); transmitting, to the user device, a confirmation request identifying the account providers associated with the at least one of the plurality of account processing system; receiving, from the user device, a confirmation response including identification of a selected account provider; generating a uniform resource location (URL) configured to launch a software application associated with the selected account provider; transmitting the URL to the user device; receiving, from the software application, a second confirmation response where the user has authenticated themselves via the software application on the user device; transmitting, to the account processing system associated with the selected account provider, the confirmation response; receiving the transaction information sufficient to complete a transaction.

Although embodiments of the present invention have been described herein in the context of a particular implementation in a particular environment for a particular purpose, those skilled in the art will recognize that its usefulness is not limited thereto and that the embodiments of the present invention can be beneficially implemented in other related environments for similar purposes. The invention should therefore not be limited by the above described embodiments, method, and examples, but by all embodiments within the scope and spirit of the invention as claimed.

As used herein, the term “bank” is not limited to a particular bank or type of bank. Rather, it is understood that the present disclosure includes any type of bank or other business involved in activities where products or services are sold or otherwise provided.

As used herein, the term “merchant” is not limited to a particular merchant or type of merchant. Rather, it is understood that the present disclosure includes any type of merchant, vendor, or other entity involved in activities where products or services are sold or otherwise provided.

As used herein, the term “account” is not limited to a particular type of account. Rather, it is understood that the term “account” can refer to a variety of accounts, including without limitation, a financial account (e.g., a credit account, a debit account), a membership account, a loyalty account, a subscription account, a services account, a utilities account, a transportation account, and a physical access account. It is further understood that the present disclosure is not limited to accounts issued by a particular entity.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

Further, it is to be understood that the terminology used herein is for the purpose of describing particular embodiments only and is not intended to be limiting. The terms “a” or “an” as used herein, are defined as one or more than one. The term “plurality” as used herein, is defined as two or more than two. The term “another” as used herein, is defined as at least a second or more. The terms “including” and/or “having,” as used herein, are defined as comprising (i.e., open language). The term “coupled,” as used herein, is defined as connected, although not necessarily directly, and not necessarily mechanically. The term “providing” is defined herein in its broadest sense, e.g., bringing/coming into physical existence, making available, and/or supplying to someone or something, in whole or in multiple parts at once or over a period of time. Also, for purposes of description herein, the terms “upper,” “lower,” “left,” “rear,” “right,” “front,” “vertical,” “horizontal,” and derivatives thereof relate to the invention as oriented in the figures and is not to be construed as limiting any feature to be a particular orientation, as said orientation may be changed based on the user's perspective of the device.

In the invention, various embodiments have been described with references to the accompanying drawings. It may, however, be evident that various modifications and changes may be made thereto, and additional embodiments may be implemented, without departing from the broader scope of the invention as set forth in the claims that follow. The invention and drawings are accordingly to be regarded in an illustrative rather than restrictive sense.

The invention is not to be limited in terms of the particular embodiments described herein, which are intended as illustrations of various aspects. Many modifications and variations can be made without departing from its spirit and scope. Functionally equivalent systems, processes and apparatuses within the scope of the invention, in addition to those enumerated herein, may be apparent from the representative descriptions herein. Such modifications and variations are intended to fall within the scope of the appended claims. The invention is to be limited only by the terms of the appended claims, along with the full scope of equivalents to which such representative claims are entitled.

It is further noted that the systems and methods described herein may be tangibly embodied in one or more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application specific integrated circuit).

The preceding description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

1. A method for completing a transaction, comprising:
receiving, by an administrator processor from a user device, a user datum;
encrypting, by an administrator processor, the user datum;
transmitting, by the administrator processor to each of a plurality of account processing systems, the encrypted user datum, wherein each account processing system is associated with a different account provider and has been provisioned with user datum encryption information;
receiving, by the administrator processor from at least one of the plurality of account processing systems, a response comprising a notification that an account holder has a transaction account processed by that account processing system;
transmitting, by the administrator processor, an authentication request to the use device;
receiving by the administrator processor an authentication credential from the user device, wherein the authentication credential comprises a one-time password (OTP);
transmitting, by the administrator processor to the user device, a confirmation request identifying the account providers associated with the at least one of the plurality of account processing system;
receiving, by the administrator processor from the user device, a confirmation response including identification of a selected account provider;
generating, by the administrator processor a uniform resource location (URL) configured to launch a software application on the user device;
transmitting, administrator processor, the URL to the user device;
receiving, by the administrator processor from the software application, a second confirmation response where the user has authenticated himself via the software application on the user device;
transmitting, by the administrator processor to the account processing system associated with the selected account provider, the confirmation response; and
receiving, by the administrator processor, the transaction information sufficient to complete a transaction.

2. The method of claim 1, wherein the user datum is one of a phone number or an email address.

3. The method of claim 1, wherein the user datum includes at least one of a home address, a billing address, a mobile phone number, a home phone number, an Email address.

4. The method of claim 1, wherein the software application associated with the selected account provider is a mobile banking app.

5. The method of claim 1, wherein the confirmation response from the software application includes biometric authentication data.

6. The method of claim 1, wherein the authentication request is transmitted via a short message service (SMS) from the administrator processor to the user device.

7. The method of claim 1, wherein if the user device does not have the software application associated with the URL, the URL will prompt the user device to download the software application.

8. The method of claim 1, wherein the URL is configured to launch one of a plurality of software applications downloaded on the user device.

9. The method of claim 1, wherein the URL is configured to launch the software application associated with the selected account provider.

10. A system, comprising:
an administrator processor configured to:
receive, by an administrator processor from a user device, a user datum;
encrypt, by an administrator processor, the user datum;
transmit, by the administrator processor to each of a plurality of account processing systems, the encrypted user datum,
receive, by the administrator processor from at least one of the plurality of account processing systems, a response comprising a notification that an account holder has a transaction account processed by that account processing system;
transmit an authentication request to a user device;
receive an authentication credential from the user device comprising a one-time password (OTP);
transmit, by the administrator processor to the user device, a confirmation request identifying the account providers associated with the at least one of the plurality of account processing system;
receive, by the administrator processor from the user device, a confirmation response including identification of a selected account provider;
generate a uniform resource location (URL) configured to launch a software application associated with the selected account provider;
transmit the URL to the user device;
receive, by the administrator processor from the software application, a second confirmation response where the user has authenticated themselves via the software application on the user device;
transmit, by the administrator processor to the account processing system associated with the selected account provider, the confirmation response; and
receive, by the administrator processor one or more transaction information sufficient to complete a transaction.

11. The system of claim 10, wherein the user device is used by a user to perform the transaction on a website or application associated with the administrator processor.

12. The system of claim 10, wherein each account processing system is associated with a different account provider and has been provisioned with the user datum encryption information.

13. The system of claim 10, wherein the administrator processor is further configured to transmit, upon receiving the transaction information sufficient to complete a transaction, the transaction information to a transaction processor configured to process the transaction.

14. The system of claim 13, wherein the administrator processor is further configured to receive a message indicating whether the transaction has been completed successfully.

15. The system of claim 10, wherein each of the account providers are associated with a transaction card owned by the user associated with the use device.

16. The system of claim 10, wherein the URL is configured such that if the user device has a plurality of software applications, then the URL will prompt the user device to selected one of the plurality of software applications to open.

17. The system of claim 10, wherein the URL is configured to open the most recently used software application.

18. The system of claim 10, wherein upon receiving the user datum, the administrator processor retrieves one or more historical transaction data associated with the user and determines whether the current transaction is likely fraudulent.

19. The system of claim 18, wherein upon determining that the current transaction is likely fraudulent, transmitting a third authentication request to the user device, and receiving from the user device a third authentication credential.

20. A non-transitory computer readable medium containing computer executable instructions that, when executed by an administrator processor, cause an administrator processor to perform procedures comprising:
receiving, from a user device, a user datum;
encrypting the user datum;
transmitting, to each of a plurality of account processing systems, the encrypted user datum, wherein each account processing system is associated with a different account provider and has been provisioned with user datum encryption information;
receiving, from at least one of the plurality of account processing systems, a response comprising a notification that an account holder has a transaction account processed by that account processing system;
transmitting an authentication request to the use device;
receiving an authentication credential from the user device comprising a one-time password (OTP);
transmitting, to the user device, a confirmation request identifying the account providers associated with the at least one of the plurality of account processing system;
receiving, from the user device, a confirmation response including identification of a selected account provider;
generating a uniform resource location (URL) configured to launch a software application associated with the selected account provider;
transmitting the URL to the user device;
receiving, from the software application, a second confirmation response where the user has authenticated themselves via the software application on the user device;
transmitting, to the account processing system associated with the selected account provider, the confirmation response; and
receiving the transaction information sufficient to complete a transaction.
